(19) United States
(12) Patent Application Publication
(10) Pub. No.: US 2025/0031101 A1
(43) Pub. Date: Jan. 23, 2025

(54) METHOD FOR ADAPTIVELY SWITCHING THE NETWORK CONNECTION OF SLAVE DEVICES BY SCENARIO DETECTION

(71) Applicant: MediaTek Singapore Pte. Ltd., Singapore (SG)

(72) Inventors: Fengyu Che, Beijing (CN); Jianwei Zhang, Beijing (CN); Nien-En Wu, Hsinchu City (TW); Mingchun Chiang, Hsinchu City (TW)

(21) Appl. No.: 18/355,988

(22) Filed: Jul. 20, 2023

(51) Int. Cl. H04W 36/00; H04W 40/28

(52) U.S. Cl. CPC H04W 36/00222; H04W 36/008357; H04W 40/28

(57) ABSTRACT

Apparatus and methods are provided for adaptively switching network connections based on scenario detection for slave mobile devices. In one embodiment, the slave mobile device monitors a plurality of sensor inputs and one or more high-layer configuration in a wide area wireless network, wherein the mobile device is configured with capabilities to keep communication to the wide area wireless network through a master device of a corresponding local connection network, generates a scenario indication based on a scenario matrix of the plurality of sensor inputs and the one or more high-layer configuration, and between the wide area wireless network and the local connection network upon determining a switch trigger based on the scenario indication and one or more lower-layer reports. In one embodiment, each indicated scenario is determined based on one or more factors including the one or more sensor inputs and the one or more high-layer configuration.

### TECHNICAL FIELD

The disclosed embodiments relate generally to wireless communication, and, more particularly, to adaptively switching the network connection of slave devices by scenario detection.

### BACKGROUND

The rapid evolution of wireless technology has transformed the way we communicate and connect in the modern era. Mobile devices, such as smartphones and tablets, have become indispensable tools for accessing information, interacting with others, and performing a wide range of tasks. Traditionally, these devices have operated as independent entities, connecting to wireless networks as clients or users. However, recent advancements have given rise to a new paradigm in wireless networks-the development of slave mobile. A slave mobile device refers to a device that collaborates with a primary device, often referred to as a master or anchor device, to enhance connectivity, expand coverage, or offload processing tasks. This concept of incorporating slave devices into wireless networks opens up numerous possibilities for improving network performance, optimizing resource utilization, and enabling innovative applications. The development of slave mobile devices offers several benefits and opportunities for both users and network operators. One significant advantage is the potential for extended coverage and improved signal strength. By strategically deploying slave devices, network operators can address coverage gaps and enhance the quality of service in areas where the primary network infrastructure may be limited. Another important benefit is the offloading of processing tasks from the primary device to the slave devices. As mobile applications and services become increasingly complex, offloading computationally intensive tasks to dedicated slave devices can relieve the burden on the primary device's resources, resulting in improved performance and energy efficiency. However, the current mobile device does not consider scenario factors in selecting network to connect.

One aspect of slave mobile devices is that they can have various network connectivity options, such as Wi-Fi or Bluetooth connections to master devices (e.g., cell phones) and cellular connections to base stations. Cellular connectivity allows slave devices to be reachable from anywhere, providing broad coverage. However, in certain scenarios like high-speed trains (HST), elevators, or basements, maintaining a cellular connection may consume more power than normal use. The current design considers network switch based on signal strength or coverage, without any considerations to scenarios of the operating slave mobile device. To address this concern, a proposed solution is to detect the specific scenarios of the slave devices and dynamically switch the network connection to save power.

Improvements and enhancements are required to detect and to perform adaptive network switching based on scenarios.

### SUMMARY

Apparatus and methods are provided for adaptively switching network connections based on scenario detection for slave mobile devices. In one embodiment, the slave mobile device monitors a plurality of sensor inputs and one or more high-layer configuration in a wide area wireless network, wherein the mobile device is configured with capabilities to keep communication to the wide area wireless network through a master device of a corresponding local connection network, generates a scenario indication based on a scenario matrix of the plurality of sensor inputs and the one or more high-layer configuration, and between the wide area wireless network and the local connection network upon determining a switch trigger based on the scenario indication and one or more lower-layer reports. In one embodiment, the slave mobile devices switch from the wide area wireless connection, such as a cellular network connection, to a local connection network. In another embodiment, the scenario detection triggers a network switch for the slave mobile device from a local connection network to a wide area wireless network. In one embodiment, each indicated scenario is determined based on one or more factors including the one or more sensor inputs and the one or more high-layer configuration. In another embodiment, the one or more sensor inputs comprising a moving status from an accelerometer, an altitude information from a barometer, an input from an altimeter, and geography information from global navigation satellite system (GNSS). The high-layer configuration comprises a high-speed flag received from the wide area wireless network. In another embodiment, the scenario matrix further includes one or more elements comprising a regular variation of SNR, a regular variation of RSRP, a sudden fluctuation of SRN, and a sudden fluctuation of RSRP. In one embodiment, the slave mobile device is one selecting from a wearable device, an Internet over Things (IoT) device, a data card, and a mobile device with capability of connection with the wide area network and wired or wireless connection with the master device. The master device is one selecting from a wireless mobile device, a cell phone, a customer premise device (CPE), a router, and a mobile device with capability of connection with the wide area network and wired or wireless connection with the mobile device. In another embodiment, the mobile device connects to the wide area wireless network through a link selecting from a cellular connection to a base station, a non-terrestrial network (NTN) connection with a satellite, and an NTN connection with an aircraft. The mobile device connects to a local connection network through a link selecting from a Wi-Fi link, a Bluetooth link, a sidelink, an ultra-wide band (UWB) link, a USB cable, and a power line communication connection.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating exemplary wireless networks with slave mobile devices configured to be able to connect to wide area wireless network directly and through local connection via master devices in accordance with embodiments of the current invention.

FIG. 2 illustrates an exemplary top level diagram of the slave mobile device adaptively switching the network connection based on scenario detection in accordance with embodiments of the current invention.

FIG. 3 illustrates an exemplary diagram of the scenario detection for the network switching of the slave mobile device in accordance with embodiments of the current invention.

FIG. 4 illustrates an exemplary diagram of the scenario determination and dynamic update for the slave mobile device in accordance with embodiments of the current invention.

FIG. 5 illustrates an exemplary diagram of different possible link connections between the slave mobile device and the master device, and between the slave mobile device and the wide area wireless network in accordance with embodiments of the current invention.

FIG. 6 illustrates an exemplary flow chart of the slave mobile device adaptively switching network connection based on scenario detections in accordance with embodiments of the current invention.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system.

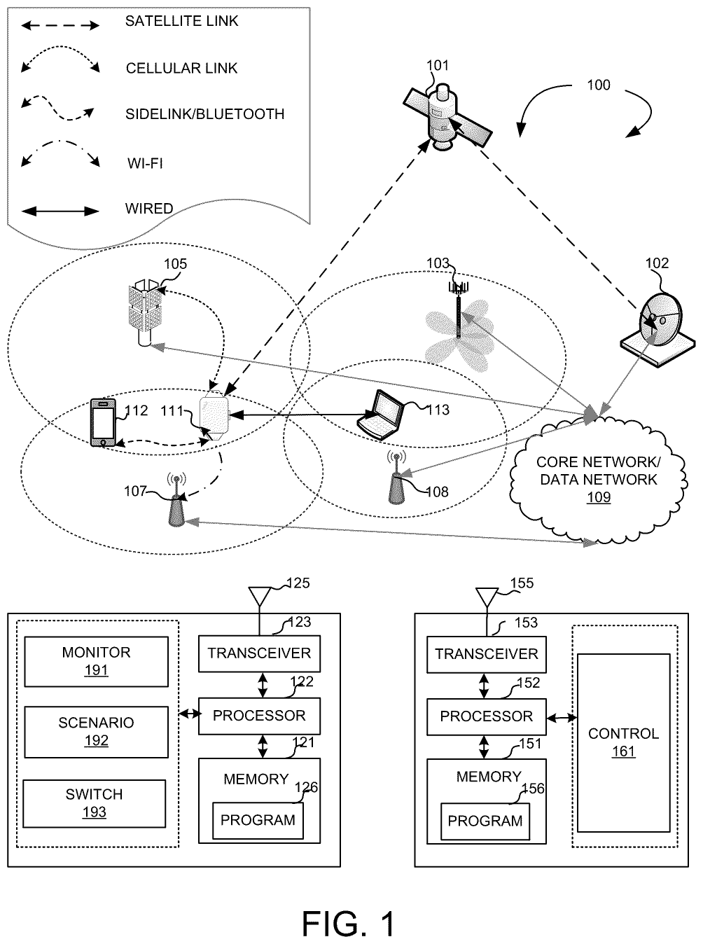

FIG. 1 is a schematic system diagram illustrating an exemplary wireless network with slave mobile devices configured to be able to connect to wide area wireless network directly and through local connection via master devices in accordance with embodiments of the current invention. Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks.

Wireless network 100 includes an exemplary cellular network configured with base stations, such as gNB 105. The cellular network has multiple communication devices or mobile stations, such as mobile phones, tablets, laptops, and other devices whether movable, mobile, or stationary. Exemplary mobile devices 111 and 112 can establish a link with gNB 105 in the cellular network. Wireless network 100 may also configured with a non-terrestrial network (NTN) refers to a network that uses radio frequency and information processing resources carried on high, medium and low orbit satellites, such as satellite 101, or other high-altitude communication platforms to provide communication services for UEs. According to the load capacity on the satellite, there are two typical scenarios: transparent payload and regenerative payload. The transparent payload mode means that the satellite will not process the signal and waveform in the communication service, but only forward the data as an RF amplifier. Regenerative payload mode refers to the satellite, besides RF amplification, also has the processing capabilities of modulation/demodulation, coding/decoding, switching, routing and so on. The NTN system includes multiple communication devices or mobile stations, such as mobile phones, tablets, laptops, and other devices whether movable, mobile, or stationary. The mobile device 111 in the NTN can establish a communication link with one or more network devices, i.e., NTN nodes, or base stations. For example, various NTN nodes 101, NTN gateway 102, and base station 103. The network node can be a communication node, such as radio access network (RAN) such as a 5G base station (gNB), an evolved universal mobile telecommunications system (UMTS), a terrestrial radio access (E-UTRA), an enhanced 4G eNodeB E-UTRA base station (eNB), e.g., an enhanced Node B, an enhanced gNB (en-gNB), or a next generation eNB (ng-eNB). The NTN node can be implemented using various non-terrestrial systems. The NTN network has multiple communication devices or mobile stations, such as mobile phones, tablets, laptops, and other devices whether movable, mobile, or stationary. Exemplary mobile devices 111 and 113 are configured with capabilities for NTN links in the NTN network. Core network/data network 109 can be a homogeneous network or heterogeneous network, which can be deployed with the same frequency or different frequencies. A 5G network entity 109 connects with gNB 103, 105 and NTN gateway 102.

In addition to the wide area network, such as the cellular network and the NTN network as illustrated above, wireless network 100 also includes local connection network that keep connection with the wide area wireless network. Exemplary local connections include Wi-Fi connection with access point (AP), such as AP 107 and 108, Bluetooth connections between devices, such as Bluetooth connections between mobile devices 111 and 112. Other local connections include sidelink connections, such as a sidelink between mobile devices 111 and 112. Wired connections, such as a USB connection between mobile devices 111 and 113. Other connections, such as ultra-wide band (UWB) connections and power line communication connections. In one exemplary scenario, mobile device 111 is a slave mobile device with connectivity with wide area wireless through direct cellular link or NTN link. Mobile device 111 can also keep connection with wireless network 100 with local connections through a master device, such as device 112 and 113. A slave mobile device, such as mobile device 111, refers to a device that collaborates with a primary device, such as device 112 or 113, often referred to as a master or anchor device, to enhance connectivity, expand coverage, or offload processing tasks. This concept of incorporating slave devices into wireless networks opens up numerous possibilities for improving network performance, optimizing resource utilization, and enabling innovative applications.

In one novel aspect, a slave mobile device is configured with capabilities to connect with the wide area wireless network, such as the cellular network, the NTN network or other wide area networks, and local connection networks through a link, such as a Wi-Fi link, a Bluetooth link, a sidelink, a UWB link, a USB cable, and a power line communication connection. The slave mobile device monitors a plurality of elements of a scenario matrix and generates a scenario indication. The slave mobile device switches between the wide area wireless network and the local connection network based on the scenario indication and other factors such the lower layer reports including the signal noise ratio (SNR) and reference signal received power (RSRP).

FIG. 1 further illustrates simplified block diagrams of a base station and a mobile device/UE that supports measurement weight factors. gNB 106 has an antenna 156, which transmits and receives radio signals. An RF transceiver circuit 153, coupled with the antenna 156, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 106. Memory 151 stores program instructions and data 154 to control the operations of gNB 106. gNB 106 also includes a set of control modules 155 that carry out functional tasks to communicate with mobile stations. These control modules can be implemented by circuits, software, firmware, or a combination of them.

FIG. 1 further illustrates simplified block diagrams of a mobile device/UE to perform embodiments of the current invention. The UE has an antenna 125, which transmits and receives radio signals. An RF transceiver circuit 123, coupled with the antenna, receives RF signals from antenna 125, converts them to baseband signals, and sends them to processor 122. In one embodiment, the RF transceiver may comprise two RF modules (not shown). RF transceiver 123 also converts received baseband signals from processor 122, converts them to RF signals, and sends out to antenna 125. Processor 122 processes the received baseband signals and invokes different functional modules to perform features in the UE. Memory (or storage medium, or computer-readable medium) 121 stores program instructions and data 126 to control the operations of the UE. Antenna 125 sends uplink transmission and receives downlink transmissions to/from base stations.

The UE also includes a set of control modules that carry out functional tasks. These control modules can be implemented by circuits, software, firmware, or a combination of them. A monitor module 191 monitors a plurality of sensor inputs and one or more high-layer configuration in a wide area wireless network, wherein the mobile device is configured with capabilities to keep communication to the wide area wireless network through a master device of a corresponding local connection network. A scenario module 192 generates a scenario indication based on a scenario matrix of the plurality of sensor inputs and the one or more high-layer configuration. A switch module 193 switches between the wide area wireless network and the local connection network through corresponding master device upon determining a switch trigger based on the scenario indication and one or more lower-layer reports.

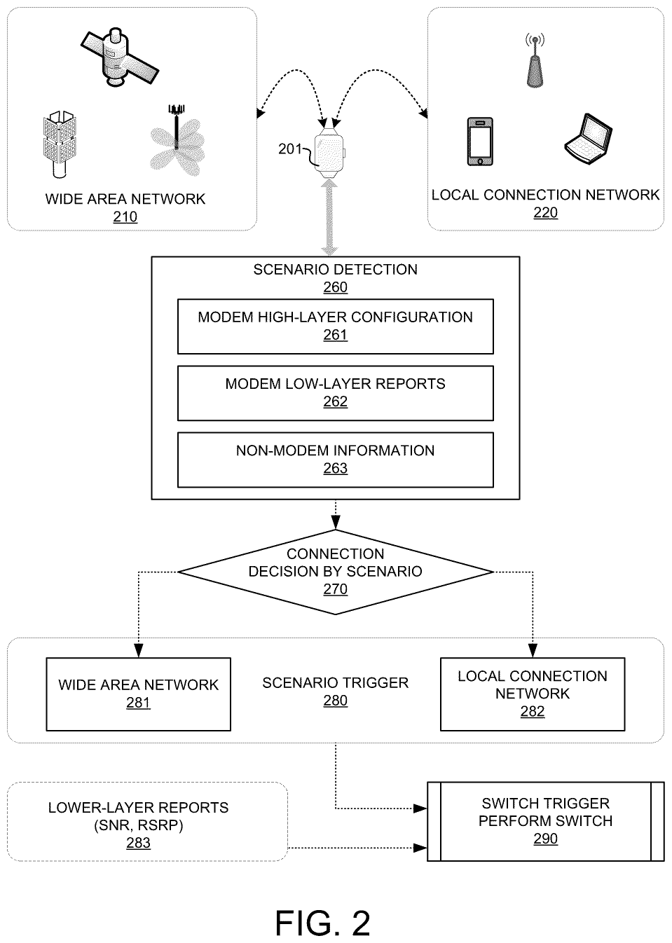

FIG. 2 illustrates an exemplary top level diagram of the slave mobile device adaptively switching the network connection based on scenario detection in accordance with embodiments of the current invention. The slave mobile device 201 is configured with capability of direct link to wide area network 210 and connection through a master device with local connection network 220. In the traditional slave mobile device settings, mobile device switches network based on network instructions or detections of predefined network availability or signal measurements, such as SNR and/or RSRP. While the direct link to the wide area network enables the slave devices reachable everywhere, it is not desirable all the time. The current network switch does not enable the slave mobile devices to the perform network switch adaptively based on different scenarios, such as HST, elevator and/or basement. In one novel aspect 260, the slave mobile device performs scenario detection. In one embodiment, the slave mobile device collects and monitors different sources, such as the modem high-layer configuration 261, the modem lower-layer reports 262, and non-modem information 263. Upon collecting set of scenario information/elements, at step 270, the UE makes connection decisions based on scenario detection. In one embodiment, scenario trigger 280 is generated based on the collected scenario factors of 260. Based on the scenario trigger, scenario decision 281 is to use the wide area wireless network, or scenario decision 282 is to use the local connection. In one embodiment, the slave mobile device switches network based on the scenario decision and, at step 290, performs network switch. In one embodiment, the network switch at step 290 switches from the wide area wireless connection to a local connection network. In another embodiment, the scenario triggers step 290 to perform switches from the local connection network to the wide area wireless connection. In one embodiment, the scenario decision is combined with other factors 283, such as lower-layer report of SNR and/or RSRP. The mobile device performs network switch based on the scenario indication/trigger 280 and other factors 283.

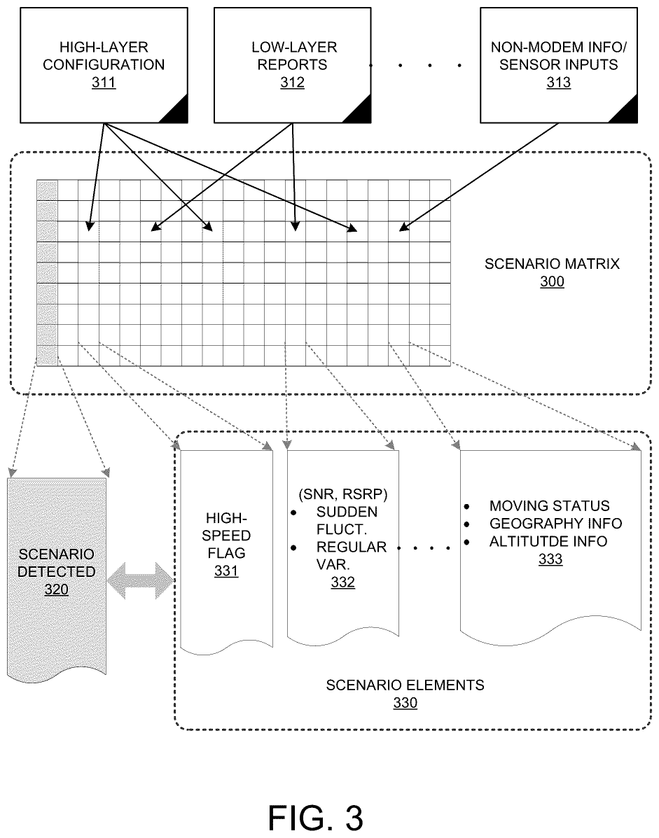

FIG. 3 illustrates an exemplary diagram of the scenario detection for the network switching of the slave mobile device in accordance with embodiments of the current invention. In one embodiment, the slave mobile device monitors and collects scenario related information including higher-layer configuration 311, lower-layer reports 312, non-modem information/sensor inputs 313 for a scenario matrix 300. Each scenario corresponds to an array of scenario elements. In one embodiment, different scenarios 320 are detected and indicated based on the collected scenario information/elements 330. In one embodiment, the higher-layer configuration 311 includes high-speed flag 331 and other high-layer information, including information received from the network related to the scenario detection. The high-speed flag 331 is received from a signal message from the wide area network indicating the system as being a high speed system. In another embodiment, the slave mobile device collects and analysis lower-layer reports such as the SNR and/or RSRP. In one embodiment 332, the scenario matrix further includes one or more elements comprising a regular variation of SNR, a regular variation of RSRP, a sudden fluctuation of SRN, and a sudden fluctuation of RSRP. The non-modem information/sensor inputs 313 includes one or more scenario factors 333 such as a moving status, an altitude information, and geography information.

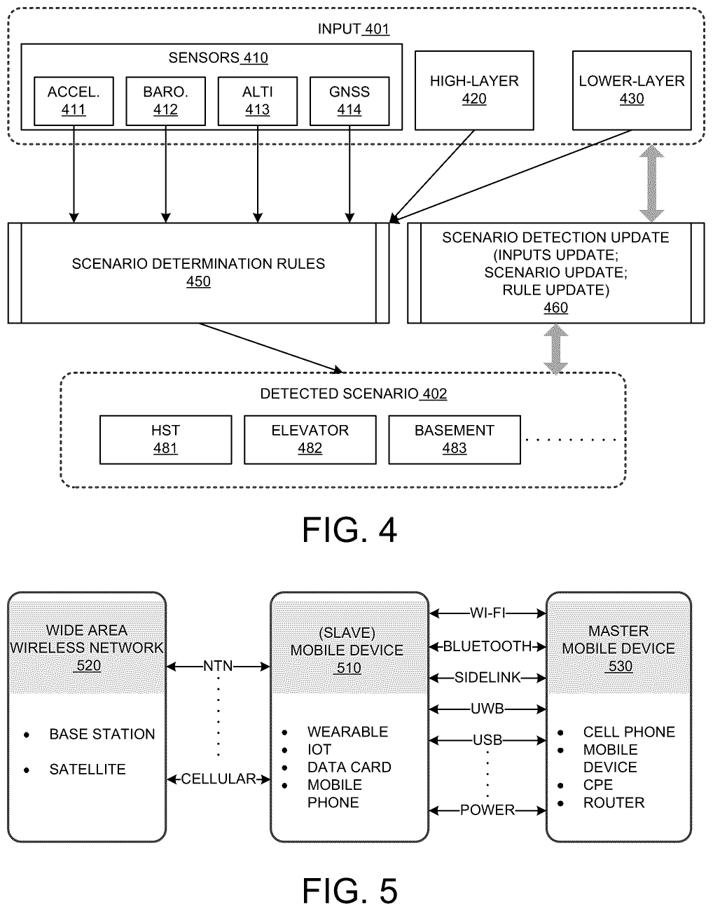

FIG. 4 illustrates an exemplary diagram of the scenario determination and dynamic update for the slave mobile device in accordance with embodiments of the current invention. In one novel aspect, the slave mobile device collects and monitors scenario information inputs 401. In one embodiment 450, the slave mobile device detects/determines one or more scenarios adaptively based on the scenario inputs 401 according to predefined/preconfigured scenario determination rules. Detected scenario 420 is generated, with scenario indications. Exemplary scenarios include HST 481, elevator scenario 482, basement scenario 483, and other related scenarios that may trigger the network switch. Scenario information inputs 401 includes sensor inputs 410, high-layer information 420, and lower-layer reports 430. Sensor inputs 410 includes a moving status from an accelerometer 411, an altitude information from a barometer 412, an input from an altimeter 413, and geography information from global navigation satellite system (GNSS) 414. For example, an HST scenario is detected based on one or more elements of scenario inputs 401. The high-speed flag received from the network of a high-layer configuration indicates a HST scenario. The analysis of lower-layer reports includes a regular variation of SNR, a regular variation of RSRP, a sudden fluctuation of SRN, and a sudden fluctuation of RSRP. The lower-layer reports are also an HST indicator to determine an HST scenario. Further, moving status from accelerometer, and geography information from GNSS may also be related to the HST scenario. In one embodiment, the slave mobile device analyzes the holistic information of the scenario input and determines a scenario indication, such as a HST indication based on one or more predefined/preconfigured scenario rules. For example, the predefined/preconfigured scenario rules include one or more thresholds for corresponding scenario inputs to indicate one or more scenarios. The slave mobile device determines the scenario accordingly. In another example, an elevator scenario is determined based on one or more scenario elements including the altitude information from barometer, inputs of altimeter, and/or GNSS information.

In one embodiment 460, the scenario detections and/or the scenario matrix are dynamically updated including the detected scenarios, the scenario inputs, and the scenario determination rules. For example, new sensor information for scenario related information is updated when new sensors are included or when new sensor information is included or updated for the existing sensors. New high-layer information and low-layer reports can be updated or added with system updates (for new messages) and/or new information related to the low-layer reports. Further, new scenarios may be added, or scenarios being updated with the expanding/development of the system. Further, the scenario detection rule can be dynamically updated, such as the scenario factor thresholds and the array of elements related to a scenario. Furthermore, the scenario detection/indication may trigger network switch between two different networks of the wide area wireless network, such as switching between a cellular network and an NTN network. It may also trigger network switch between different local connections.

FIG. 5 illustrates an exemplary diagram of different possible link connections between the slave mobile device and the master device, and between the slave mobile device and the wide area wireless network in accordance with embodiments of the current invention. Slave devices are becoming increasingly popular as they offer a number of advantages over traditional. The basic architecture includes wide area wireless network 520, different slave mobile devices 510, and master mobile devices 530. As wireless networks continue to advance, the development of slave mobile devices presents a promising avenue for enhancing network performance, extending coverage, and enabling innovative applications. The list of wide area wireless 520, different slave mobile devices 510, and master mobile devices 530 are exemplary lists. The adaptive network switching presented here can be dynamically updated to include new and/or updated system architects. In one embodiment, the (slave) mobile device 510 includes a wearable device, an Internet over Things (IoT) device, a data card, and any mobile device with capability of connection with the wide area network and wired or wireless connection with the master device. The master device 530 includes a wireless mobile device, a cell phone, a customer premise device (CPE), a router, and any mobile device with capability of connection with the wide area network and wired or wireless connection with the mobile device. The wide area network 520 includes a cellular network with base stations, and an NTN network with satellite connections. In one embodiment, the (slave) mobile device 501 connects to the wide area wireless network 520 through a link selecting from a cellular connection to a base station, a non-terrestrial network (NTN) connection with a satellite, and an NTN connection with an aircraft, or any other links to the wide area wireless network. (Slave) mobile device 510 connects to a local connection network 530 through a link selecting from a Wi-Fi link, a Bluetooth link, a sidelink, an ultra-wide band (UWB) link, a USB cable, a power line communication connection, or any other wireless or wired local area connections.

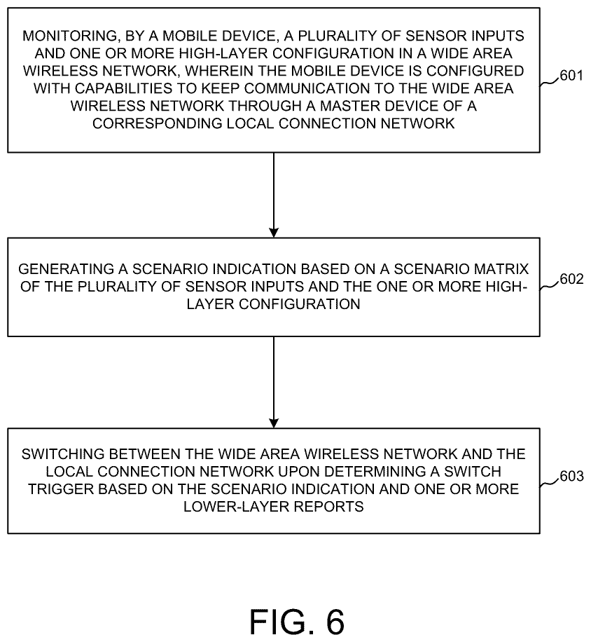

FIG. 6 illustrates an exemplary flow chart of the slave mobile device adaptively switching network connection based on scenario detections in accordance with embodiments of the current invention. At step 601, the mobile device monitors a plurality of sensor inputs and one or more high-layer configuration in a wide area wireless network, wherein the mobile device is configured with capabilities to keep communication to the wide area wireless network through a master device of a corresponding local connection network. At step 602, the mobile device generates a scenario indication based on a scenario matrix of the plurality of sensor inputs and the one or more high-layer configuration. At step 603, the mobile device switches between the wide area wireless network and the local connection network upon determining a switch trigger based on the scenario indication and one or more lower-layer reports.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
monitoring, by a mobile device, a plurality of sensor inputs and one or more high-layer configuration in a wide area wireless network, wherein the mobile device is configured with capabilities to keep communication to the wide area wireless network through a master device of a corresponding local connection network;
generating a scenario indication based on a scenario matrix of the plurality of sensor inputs and the one or more high-layer configuration; and
switching between the wide area wireless network and the local connection network upon determining a switch trigger based on the scenario indication and one or more lower-layer reports.

2. The method of claim 1, wherein the scenario indicator indicates one or more scenarios comprising a high speed transportation (HST) scenario, an elevator scenario, a basement scenario, and a special scenario for wide area wireless network.

3. The method of claim 2, wherein the one or more scenarios are adaptively updated.

4. The method of claim 2, wherein each indicated scenario is determined based on one or more factors including the one or more sensor inputs and the one or more high-layer configuration.

5. The method of claim 1, wherein the one or more sensor inputs comprising a moving status from an accelerometer, an altitude information from a barometer, an input from an altimeter, and geography information from global navigation satellite system (GNSS).

6. The method of claim 1, wherein the high-layer configuration comprising a high-speed flag received from the wide area wireless network.

7. The method of claim 1, wherein the lower-layer reports comprising signal to noise ratios (SNR) and reference signal received power (RSRP).

8. The method of claim 7, wherein the scenario matrix further includes one or more elements comprising a regular variation of SNR, a regular variation of RSRP, a sudden fluctuation of SRN, and a sudden fluctuation of RSRP.

9. The method of claim 1, wherein the mobile device is one selecting from a wearable device, an Internet over Things (IoT) device, a data card, and a mobile device with capability of connection with the wide area network and wired or wireless connection with the master device, and wherein the master device is one selecting from a wireless mobile device, a cell phone, a customer premise device (CPE), a router, and a mobile device with capability of connection with the wide area network and wired or wireless connection with the mobile device.

10. The method of claim 1, wherein the mobile device connects to the wide area wireless network through a link selecting from a cellular connection to a base station, a non-terrestrial network (NTN) connection with a satellite, and an NTN connection with an aircraft, and wherein the mobile device connects to a local connection network through a link selecting from a Wi-Fi link, a Bluetooth link, a sidelink, an ultra-wide band (UWB) link, a USB cable, and a power line communication connection.

11. A mobile device, comprising:
a transceiver that transmits and receives radio frequency (RF) signal in a wide area wireless network;
a monitor module that monitors a plurality of sensor inputs and one or more high-layer configuration in a wide area wireless network, wherein the mobile device is configured with capabilities to keep communication to the wide area wireless network through a master device of a corresponding local connection network;
a scenario module that generates a scenario indication based on a scenario matrix of the plurality of sensor inputs and the one or more high-layer configuration; and
a switch module that switches between the wide area wireless network and the local connection network through corresponding master device upon determining a switch trigger based on the scenario indication and one or more lower-layer reports.

12. The mobile device of claim 11, wherein the scenario indicator indicates one or more scenarios comprising a high speed transportation (HST) scenario, an elevator scenario, a basement scenario, and a special scenario for wide area wireless network.

13. The mobile device of claim 13, wherein the one or more scenarios are adaptively updated.

14. The mobile device of claim 13, wherein each indicated scenario is determined based on one or more factors including the one or more sensor inputs and the one or more high-layer configuration.

15. The mobile device of claim 11, wherein the one or more sensor inputs comprising a moving status from an accelerometer, an altitude information from a barometer, an input from an altimeter, and geography information from global navigation satellite system (GNSS).

16. The mobile device of claim 11, wherein the high-layer configuration comprising a high-speed flag received from the wide area wireless network.

17. The mobile device of claim 11, wherein the lower-layer reports comprising signal to noise ratios (SNR) and reference signal received power (RSRP).

18. The mobile device of claim 17, wherein the scenario matrix further includes one or more elements comprising a regular variation of SNR, a regular variation of RSRP, a sudden fluctuation of SRN, and a sudden fluctuation of RSRP.

19. The mobile device of claim 11, wherein the mobile device is one selecting from a wearable device, an Internet over Things (IoT) device, a data card, and a mobile device with capability of connection with the wide area network and wired or wireless connection with a master device, and wherein the master device is one selecting from a wireless mobile device, a cell phone, a customer premise device (CPE), a router, and a mobile device with capability of connection with the wide area network and wired or wireless connection with a device.

20. The mobile device of claim 11, wherein the mobile device connects to the wide area wireless network through a link selecting from a cellular connection to a base station, a non-terrestrial network (NTN) connection with a satellite, and an NTN connection with an aircraft, and wherein the mobile device connects to a local connection network through a link selecting from a Wi-Fi link, a Bluetooth link, a sidelink, an ultra-wide band (UWB) link, a USB cable, and a power line communication connection.
